(19) United States
(12) Patent Application Publication
(10) Pub. No.: US 2004/0019550 A1
(43) Pub. Date: Jan. 29, 2004

(54) Intangible property enumerating method and system

(76) Inventors: Rochit Rajsuman, Santa Clara, CA (US); Hiroaki Yamoto, Santa Clara, CA (US)

Correspondence Address: MURAMATSU & ASSOCIATES, Suite 225, 7700 Irvine Center Drive, Irvine, CA, 92618, US

(21) Appl. No.: 10/206,713

(22) Filed: Jul. 27, 2002

(51) Int. Cl. G06F 17/60

(52) U.S. Cl. 705/36

(57) ABSTRACT

An intangible property management method and system to enumerate and account intangible property is described. The intangible property management system utilizes a computer system which uses various domains of the intangible property to enumerate and account intangible property based on relationships with various business parameters. The system is configured by a computer system for executing a program and processing data describing the intangible assets interrelated with business parameters, and a multi-dimensional chart having multiple domains which are assigned with types of intangible property and business parameters.

### FIELD OF THE INVENTION

This invention relates to an intangible property management method and system to enumerate and account intangible property, and more particularly, to an intangible property management method and system using a computer to enumerate and account intangible property using a multi-dimensional chart.

### BACKGROUND OF THE INVENTION

In the recent years, it has been recognized that intangible property is one of the key assets of a corporation or an organization. Intellectual property (intangible assets) includes a wide range of assets such as patents, trademarks, trade secrets, copyrighted expression, design, artwork and software as well as strategic contracts, partnerships and alliances. The intangible property can be a direct source of revenue in terms of royalty as well as a determining factor of the company's future growth, development of products and competitive positioning.

While the corporate management, financiers, wall-street and share holders are increasingly aware of the value of intangible property, there is no known method for enumeration and accounting of intangible property. To the best of the inventor's knowledge, the only method in use today is a numeric count of intangible property such as patents. For example, companies such as IBM provide a numeric count of patents in its annual report and the financial statement specifies the royalty revenue obtained by licensing its patents.

However, such a method does not provide a true value of intangible property held by a company. Thus, a user is faced with a difficulty in visualizing the value of intangible property held by a company. The management, financiers, wall-street and share holders often have the need to communicate regarding intangible assets in a corporation, but such an effort poses hardship due to the lack of effectively representing the intangible assets. Moreover, such numeric representation fails to illuminate the interrelationship among several asset classes, such as revenues, alliances and partnerships. Thus, there is an urgent need for a method and system to enumerate and account intangible property in an effective way.

### SUMMARY OF THE INVENTION

The present invention has been made to resolve the problems involved in enumerating and accounting intangible property, and it is, therefore, an object of the present invention to provide a computer-implemented method to manage the intangible property with use of multi-dimensional representation.

It is another object of the present invention is to provide a computer-implemented method to manage the intangible assets by utilizing a multi-dimensional chart to enumerate and account the intangible assets.

It is a further object of the present invention to provide a step-by-step approach to create the multi-dimensional chart for illustrating interrelationship among various asset classes and parameters concerning the intangible property management.

In this invention, a multi-dimensional chart is created to enumerate various classes of intangible assets and organize them according to a product or market segment or organization. The system for enumerating and accounting the intangible assets is comprised of a computer system for executing a program for enumerating and accounting the intangible assets and processing data describing the intangible assets interrelated with business parameters, and a multi-dimensional chart having multiple domains which are assigned with types of intangible property and the business parameters. Accordingly, the multi-dimensional chart illustrates the intangible assets interrelated with the business parameters with three or more dimensions at the same time.

In the intangible asset enumerating system of the present invention, the multi-dimensional chart illustrates the intangible assets with specified fonts, color, background patterns and shades to differentiate properties, scope, interactions and status of the intangible assets when visual representation is used. The computer system rotates an axis or plane in the multi-dimensional chart to visualize a desired domain at a desired location of the multi-dimensional chart.

The multi-dimensional chart in the intangible asset enumerating system illustrates the intangible assets based on relationships with at least one predetermined product. The multi-dimensional chart in the intangible asset enumerating system illustrates the intangible assets based on relationships with at least one group or division of a corporation or at least one corporation.

Another aspect of the present invention is a method of enumerating and accounting intangible assets. The method is comprised of the steps of: determining requirements and scopes for representing intangible assets and business parameters, determining a number of domains of a multi-dimensional chart based on the requirements and scopes, assigning types of intangible assets and business parameters to the domains of the multi-dimensional chart, creating lists of data describing particulars of each of the intangible assets, completing the multi-dimensional chart by combining the lists of data, thereby illustrating the intangible assets with relationship with the business parameters in a multi-dimensional format.

The intangible asset enumerating method of the present invention further includes a process in which the multi-dimensional chart illustrates the intangible assets with specified fonts, color, background patterns and shades to differentiate properties, scope, interactions and status of the intangible assets. Further, the intangible asset enumerating method further includes a process in which an axis or plane in the multi-dimensional chart is rotated to visualize a desired domain at a desired location of the multi-dimensional chart.

In the intangible asset enumerating method, the multi-dimensional chart illustrates the intangible assets based on relationships with at least one predetermined product. The multi-dimensional chart of the intangible asset enumerating method illustrates the intangible assets based on relationships with at least one group or division of a corporation or at least one corporation.

In the present invention, because of this specific arrangement and enumeration, the multi-dimensional chart illuminates the interaction among various intangible assets for a product, for multiple products within a class as well as interaction among various classes and domains. Besides enumerating and accounting, the multi-dimensional chart is also useful to obtain guidance for the next phase development for a product, next product development, marketing and competitive positioning and the valuation of a product and organization.

### BRIEF DESCRIPTION OF THE DRAWINGS

FIG. 1A is a schematic diagram showing an example of hardware configuration for implementing the present invention, and FIG. 1B is a schematic diagram showing an example of display system for data entry and display in the present invention.

FIG. 2 is an example of basic structure of a multi-dimensional display of the present invention depicting four domains.

FIG. 3 is an example of illustration of the R-chart of the present invention corresponding to the four domains of FIG. 2 wherein asset types and other parameters are assigned to the domains.

FIG. 4A shows a listing of trademarks with their scope and interaction, FIG. 4B shows a listing of patents with their scope, interaction and status, and FIG. 4C is an illustration of a complete example of the R-chart of the present invention which lists the intangible assets with their scope, interaction and status.

FIG. 5 is a diagram showing an example of graphical representation using the R-chart of the present invention depicting six domains.

FIG. 6 is a diagram showing an example of graphical representation using the R-chart of the present invention showing a list of patents related to two different types of products.

FIG. 7 is a flow chart showing a process for creating the R-chart of the present invention based on various asset types and business parameters.

### DETAILED DESCRIPTION OF THE INVENTION

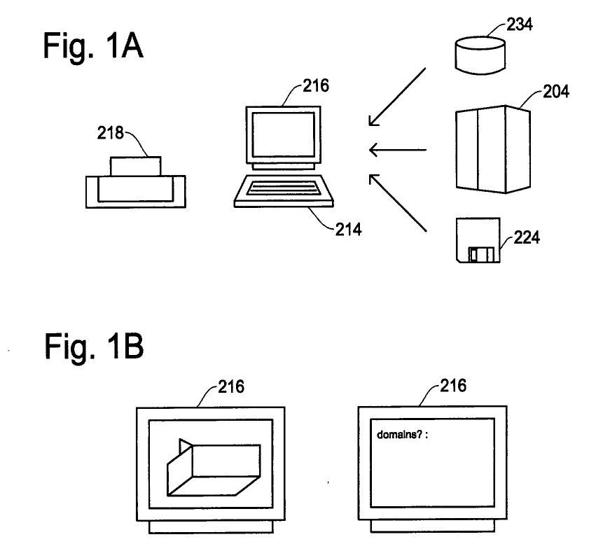

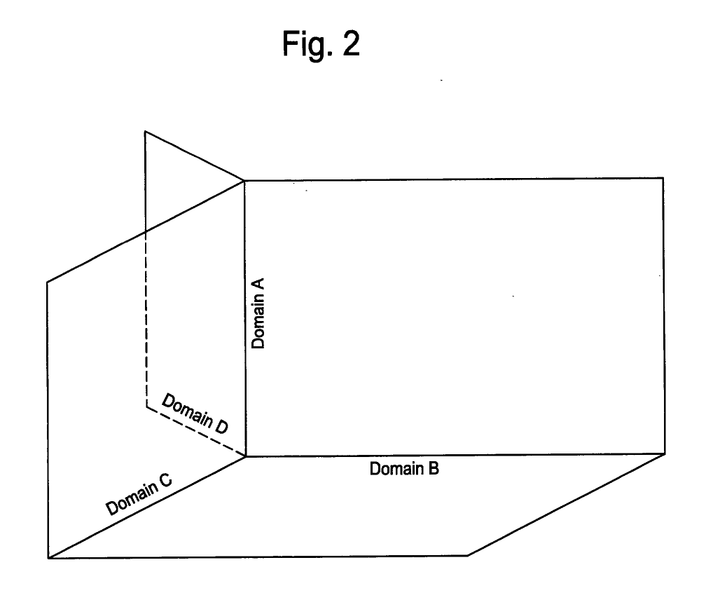

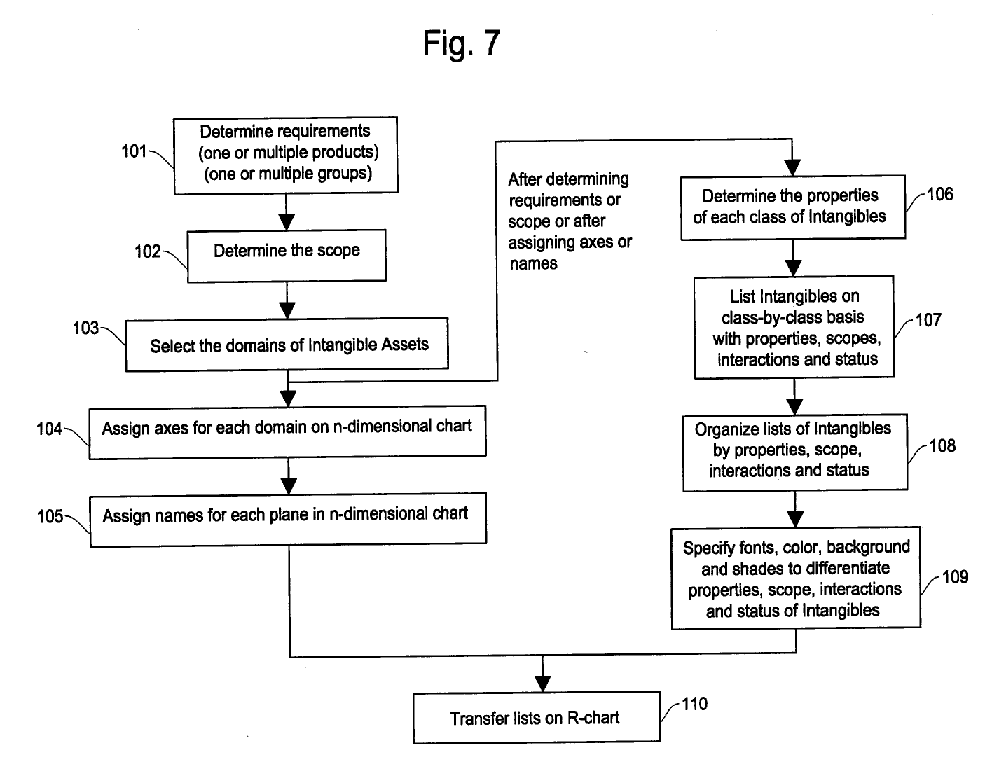

The present invention is now described in more detail with reference to the accompanying drawings. An example of hardware configuration for implementing the present invention is shown in FIGS. 1A and 1B. The structure and display examples of a multiple dimensional graphical representation (inventors call it “R-chart”) of the present invention is described with reference to FIGS. 2-6. The flow chart of FIG. 7 shows a process for creating the R-chart. Within the context of the present invention, the R-chart is a multi-dimensional chart to enumerate various classes of intangible asset and organize them according to various parameters such as a product, market segment, organization or the like.

As shown in FIGS. 1A and 1B, the present invention is implemented by a computer system such as a personal computer or a workstation with use of an interface such as a graphic user interface (GUI). Although not shown, such a computer system may be connected to other computer systems through a local area network (LAN) or a public communication network such as Internet to exchange data in the organization. For example, the computer system sends and receives corporate management information, accounting information, patent management data, and the like. The computer system is also able to receive patent data and legal data through publicly accessible databases through the communication network such as Internet.

The user defines domains and their names by entering data from an input device such as a keyboard 214 or by using preexisting data. Such preexisting data may be retrieved from any medium, including a main frame 204, a floppy disk 224, or a hard disk of a computer. A display 216 displays the multi-dimensional presentation (R-chart) of the present invention. If necessary, the R-chart will be printed out by a printer 218. As shown in FIG. 1B, the computer display 216 is preferably a graphic user interface (GUI) to show graphic representation of axes interactively as the user enters the data, or it can be a console user interface (CUI) wherein a user inputs text data.

FIG. 2 shows a basic structure of the R-chart of the present invention. In this example, the R-chart has four domains (planes) indicated by Domain A, Domain B, Domain C and Domain D. As shown in FIG. 2, each domain represents one axis or plane of the R-chart. In other words, each domain (plane) is defined by two axes in the R-chart. Preferably, such domains are illustrated by difference colors. The number of domains and the assignment of data to the domains and an arrangement of each domain to each axis will be made based on the requirements and scopes for enumerating and accounting intangible property which will be explained in detail later.

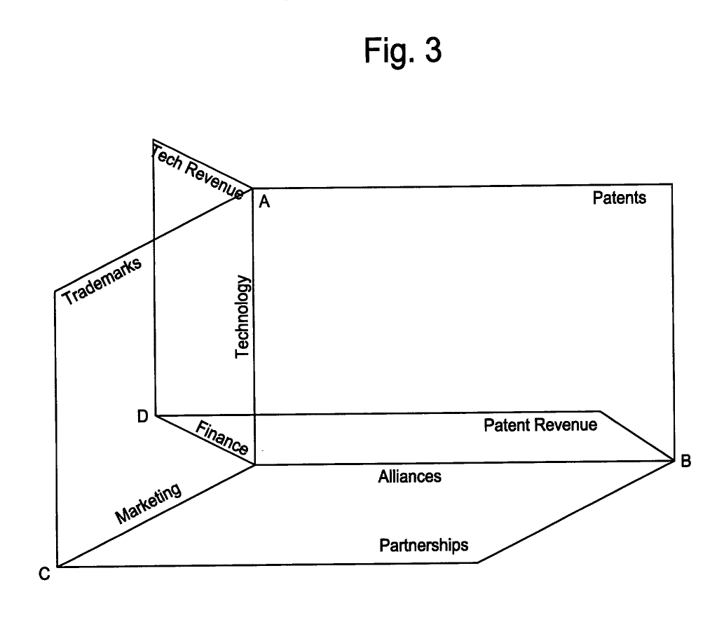

FIG. 3 shows the R-chart of the present invention corresponding to the four domains of FIG. 2 wherein asset types and other parameters are assigned to the planes of domains. Namely, each domain of the R-chart is assigned with a name of intangible asset or financial or other business parameters. In this example, the axis (domain) A is assigned with “Patents” or “Technology”, the axis (domain) B is assigned with “Alliances” or “Partnerships”, the axis (domain) C is assigned with “Trademarks” or “Marketing”, and the axis (domain) D is assigned with “Technical Revenue” or “Finance”.

In this manner, the property types and business parameters are assigned to each plane (domain) defined by the axes on the n-dimensional chart. As shown in the example of FIG. 3, the “Alliances” domain is illustrated horizontally, and the “Technology” domain is aligned vertically. It should be noted that such particular assignment of assets and business parameters is not limited to the one shown in the preferred embodiment. Any arrangement of the R-chart can be possible within the concept of the present invention. Further, in this example, only one class of intangible assets, such as “Patents” is assigned to one plane. However, it should be noted that each plane may contain two or more classes of assets; for example, Plane A-B may contain “Patents”, “Design”, “Trade secrets”, etc.

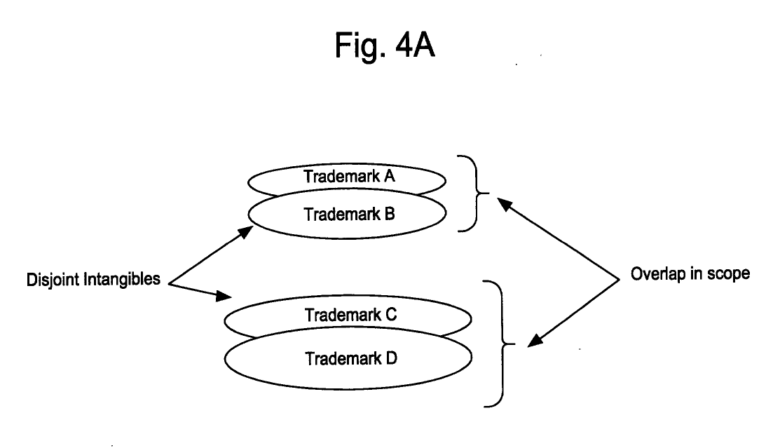

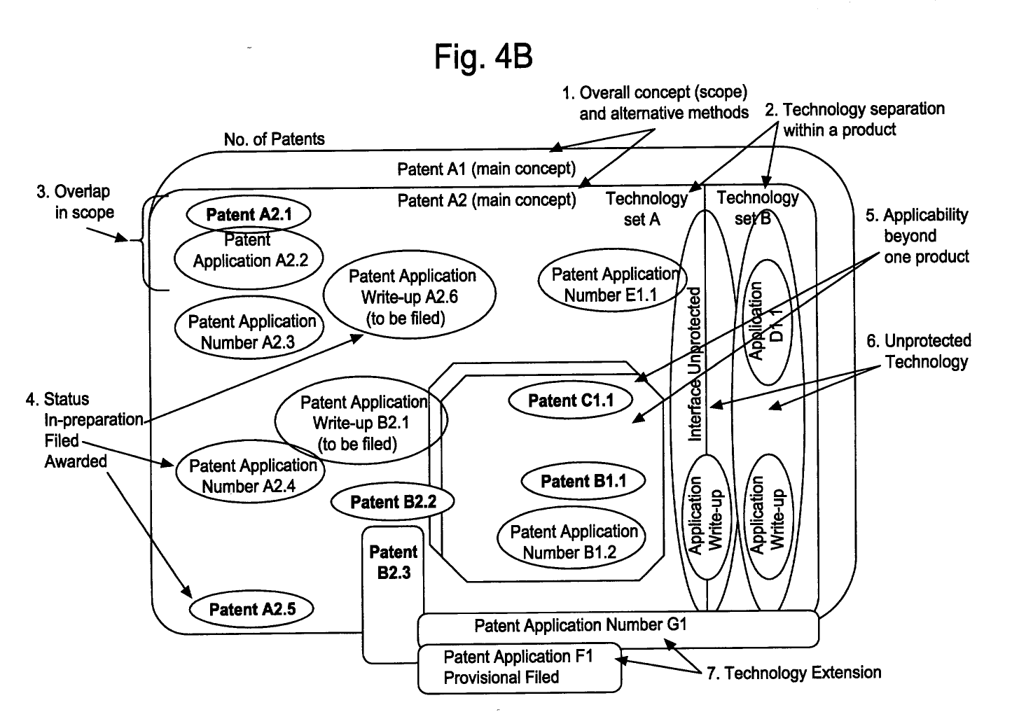

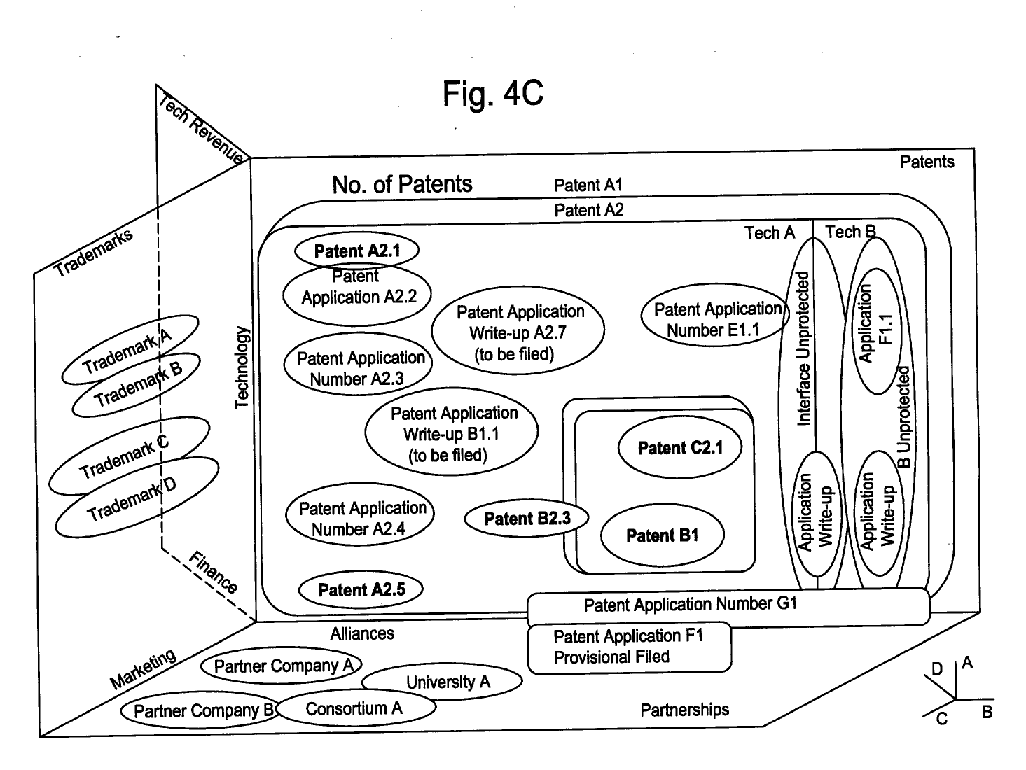

FIGS. 4A-4C show an example of process for creating the R-chart of the present invention. FIG. 4A shows a listing of trademarks as intangible property with their scope and interaction, and FIG. 4B shows a listing of patent assets with their scope, interaction and status, and FIG. 4C is a complete example of representation of the intangible assets with their scope, interaction and status depicted based on the listings of FIGS. 4A and 4B.

To create the R-chart of FIG. 4C, firstly, a list of types of intangible assets is prepared. Such a list should also include identification, features, scope, interactions and procedural status of each asset, etc. as shown in FIGS. 4A and 4B. Information for creating such a list can be obtained from a publicly available database such as a patent database and a trademark database produced by U.S. Patent and Trademark Office. Information which is not publicly available, such as trade secrets, may be obtained from a particular group, for example, an intellectual property department of a corporation handling such information.

FIG. 4A shows an example of trademark list which enumerates trademarks and service marks (marks) of a corporation. This example shows four trademarks which are organized based on the scope of the marks. Determination of such scopes include evaluation of similarity of marks, goods and services using the marks, and strength such as distinctiveness of the marks, etc. When the scopes of particular marks overlap with each other, such an overlapping state is preferably illustrated in a graphical manner in the list, such as Trademarks A and B or Trademarks C and D in FIG. 4A.

Although not shown, the list of FIG. 4A may further include a filing date, application number, current status of each trademark and service mark. If the mark is registered, a registration number of the mark and renewal date will also be listed. Other information that should be included in the list is a name of person and division that proposed the mark, whether the mark is actually used or not, any license agreement involved, or likelihood of infringement by a third party, and etc.

FIG. 4B shows an example of patent list which lists patents of a corporation. The patent list may or may not include information on design patent. Preferably, a design patent list is created separately from the utility patent list of FIG. 4B since design patents are directed to ornamental appearance rather than technology. The lists are organized in such a way as to visually represent their properties and relationships. The user may input the lists of patent through the input device 214 (FIG. 1A), or the computer may retrieve data from an appropriate storage device or from a remote database if pre-existing data is available.

The patent list includes, with respect to each patent, identification such as a title of the invention, inventor's name, subject matter or essential feature of the invention, filing date, application number, type of award and date of awarded, and patent number. In the example of FIG. 4B, the information in the patent list is organized in seven categories: (1) overall concept (scope) and alternative methods, (2) technology separation within a product, (3) overlap with other patent in scope, (4) status (in reparation, filed, awarded, patent issued, etc.), (5) applicability to other products, (6) unprotected technology, and (7) technology extension. The contents of the patent list is 7 parameters in this case to keep the figures simple but is not limited in this example. A user may use less or more parameters based on the specific application.

Since the lists have to show many different types of information, these properties, scopes, interactions and statuses are identified and differentiated by various fonts, colors, background patterns and shades. A software for implementing the present invention may automatically set such fonts, color, background patterns and shades, or the user may manually select them based on preference. Thus, although the accompanying drawings do not show colors or patterns, the actual implementation on computer screen or paper printout shows colors or patterns to help visualize the intangibles with their scope, interaction and status. For example, the “technology extension” section in FIG. 4B may have Times New Roman font with purple background while the “overlap in scope” section may have Courier font with green background, etc.

Those lists are transferred to the R-chart as shown in FIG. 4C. To avoid cluttering and simplify the illustration, only the lists on the planes A-B, B-C and A-C are shown in FIG. 4C. This complete graphic representation is displayed on a display such as a computer display or is printed by a printer. Thus, the axis A (Technology) and the axis B (Alliances) define the plane A-B which shows the data created for the type of intangible asset “Patents”. In this example, as noted above, the patents are organized under seven categories. Preferably, the type of parameters or categories, type of assets and the planes are displayed by different colors, background patterns, shades, and fonts to help easy observation of the relationship. This visual representation helps the user to see the interrelationship among the intangible assets, products using the assets and business parameters.

The above procedure is repeated for other planes of the R-chart with respect to other type of intangible assets, products using the intangible assets and various business parameters. For example, although not shown in the drawings, a list for the plane A-D, which is directed to financial aspect of the intangible assets, may contain the costs of filing and maintaining each patent and trademark and the royalty generated by licensing these patents and trademarks. Since the plane A-D displays the financial data, the list for the plane A-B may be limited only to the technical aspect of the patents.

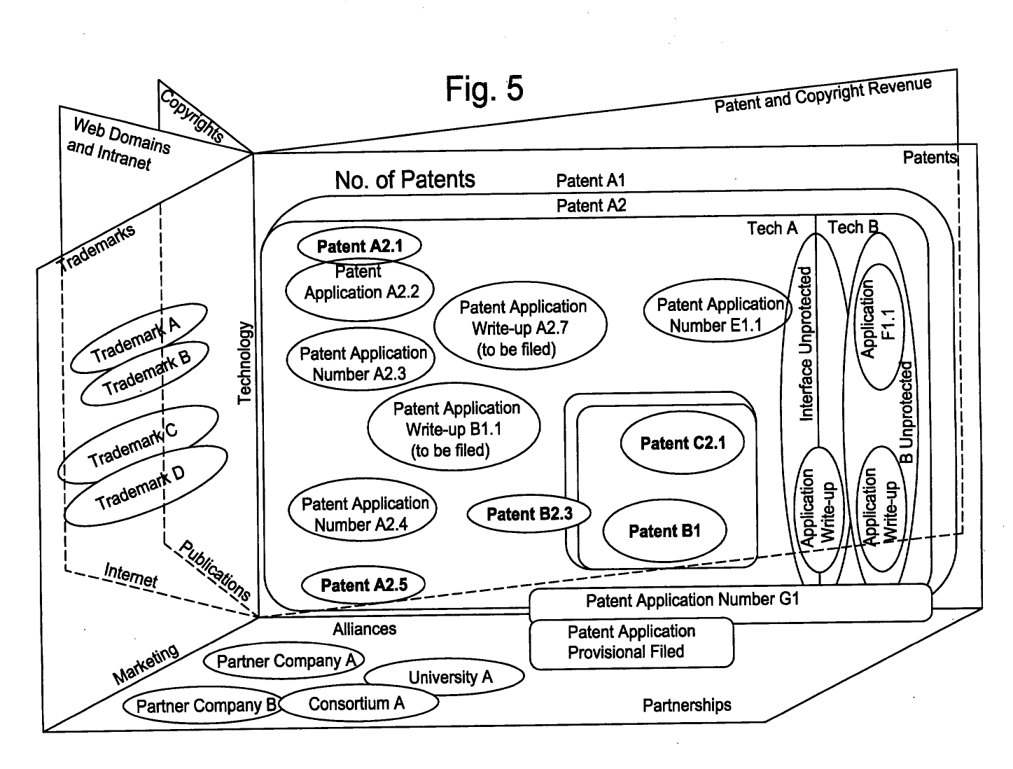

It should be noted that the above procedure is not limited to any fixed number of domains or planes. Any number of domains and corresponding planes can be used in the R-chart of the present invention. For example, FIG. 5 illustrates an R-chart having six dimensional axes or planes, unlike the four domains (planes) in the above embodiment. The example of FIG. 5 shows a plane assigned with “Web domains and intranet”, another plane assigned with “Copyrights”, and a further domain assigned with “Patent and copyright revenue” in addition to the planes illustrating the “Patent”, “Trademark” and “Partnership”. The basic concept and procedure to create the R-chart is the same as that described above.

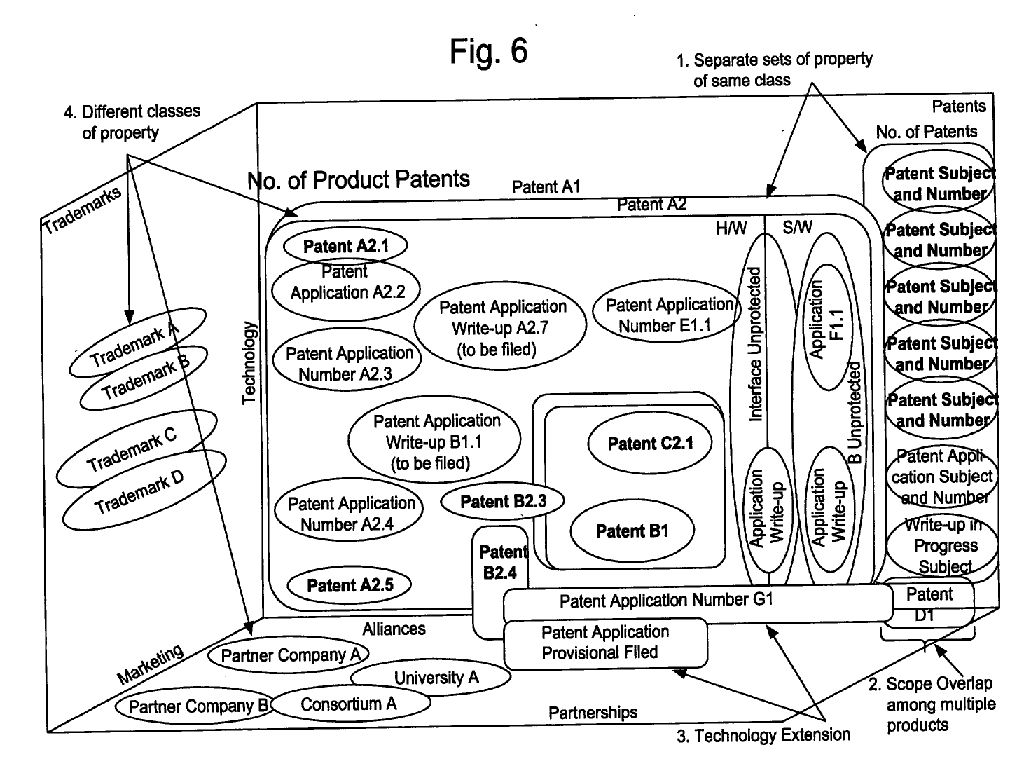

Further, in the above example, the scope is limited to one product in one division of a corporation. However, it should be noted that the basic concept and procedure to create the R-chart is applicable to any number of products, any number of groups and divisions as well as a whole corporation. It can even be extended to encompass two or more corporations. For example, FIG. 6 illustrates lists of information on the patents related to two different sets of products. Also, if desired, these two sets can be divided into two different planes; in that case each plane will represent the intangible asset type “Patent” organized by an individual product.

Further, it should be noted that these listings can be arranged based upon any other selected criteria, for example, single country or worldwide, relationship with affiliated companies, relationship with competitor's patents, old product or new product, etc.

Finally, even though the preferred embodiment shows a particular plane in a particular position, all of the axis or planes can be rotated with respect to each other so that any domain (plane) can be a desired position such as a front view of the R-chart. This rotational capability allows an easy visualization of the list of a particular set of intangible property, or values or characteristics along a particular axis. For example, the plane B-D can be brought to a front view in a manner similar to the plane A-B of FIG. 4C to show the revenue and cost of patents.

By the specific arrangement and enumeration, the R-chart illuminates the interaction among the various intangible assets for a product, for multiple products within selected types as well as interaction among various types and domains. Besides enumerating and accounting, the R-chart is also useful to obtain guidance for the next phase product development, product planning and strategic analysis, product marketing and competitive positioning and the valuation of a product and organization.

FIG. 7 is a flow chart summarizing the process for creating the R-chart of the present invention. At step 101, requirements of the R-chart, such as a covering range, is determined. An example of such a covering range is a range of products, such as one or multiple products and/or a range of groups, divisions etc of a particular corporation. Thus, it is determined whether a user wants to assess the intangible assets for one product or multiple products, or one division or multiple divisions of corporations.

Similarly, at step 102, the scope of the management system must be determined. The scopes may be as wide as all intangible assets of the corporation or may be limited to a particular class of intangible assets such as patents. In the example of FIG. 4A describe above, the scopes of the R-chart are all intangible assets related to one product in one division of a corporation.

In step 103, the domains of the intangible assets must be selected for the R-chart. As a preferred embodiment, FIGS. 2 and 3 show four domains, making a four-dimensional R-chart. Thus, the domains A, B, C and D are defined. In step 104, the axes of the R-chart are assigned to the selected domains on the R-chart. In the foregoing process, the number of domains and the assignment of information to the domains are made based on the requirements and scopes of enumerating and accounting the intangible assets determined in the steps 101 and 102.

At step 105, each domain is assigned with a name, for example, the name “Technology” is assigned to domain A, the name “Alliances” is assigned to domain B in the example of FIG. 3. Next, at step 106, the properties of each class of intangible asset is determined. In the above example, various patents and patent applications, or trademarks are selected for constituting the R-chart. This process can be done any time after determining the requirements and scopes in the steps 101 and 102 or after assigning the axes or names to each plane in the steps 104 and 105.

At step 107, the lists are created which show various information of each asset in a class by class basis, including status, scopes, interactions. For the case of patent, such properties include title of the invention, inventor's name, section or division of the inventor, patent application number, application date, issued patent number, essential feature, claim coverage or scope, etc. In the case where particular two or more patents are overlapped in the scope with one another, for example, continuation applications, such a relationship will be illustrated in a visual manner by partially overlapping the images. Preferably, as in step 108, such lists of properties are organized in the plane so as to be displayed in an effective and uniform way.

At step 109, to display the R-chart in an easily discernible and comprehensible manner, these properties, scopes, interactions and statuses are identified and differentiated by various fonts, colors, background patterns and shades. As noted above, the computer program running this management method may automatically set such fonts, colors, patterns and shades, or the user may manually select them according to preference.

Lastly, the lists created in the above are transferred to the R-chart at step 110, thereby completing the R-chart such as shown in FIGS. 4C, 5 and 6. The graphic representation of the R-chart is displayed on a display screen or is printed by a printer. This visual representation helps the user to see the relationship among the intangible assets, products involved, and business parameters at a glance.

Although the preferred embodiment is created by the above noted steps in the order that would be most natural to many people, the present invention is not limited to the particular order described above. For example, properties of each class of intangible asset may be determined right after the requirements are determined.

The present invention is very valuable for the management as well as to any other concerned party such as financiers. In the simplest form, it gives a visual representation and an accounting method for intangible assets. To the best of the inventors knowledge, this invention is the first systematic attempt to enumerate and account intangible assets.

The present invention is also very useful as a communication method for corporate management to any other concerned parties such as shareholders and board of directors. This chart identifies strengths and weaknesses in the asset type and technology. For example, when the coverage of patents related to a technology is overlapping, that technology can be considered being protected; however, disjoint coverage identifies weakness and subsequently indicates target technology topics that should be protected.

This method is very useful in the asset management and helps corporate management in forming strategies for the next phase development, products, alliances, marketing and even steps against competitors. For example, the unprotected technology as shown in FIG. 4C identifies that management should take necessary steps to secure it. Similarly, the technology extension patents in FIG. 4C identify possible next phase development or future products. Because of this detailed accounting, this method is also very useful for company's valuation by the financiers as well as for corporate mergers and acquisitions as well as strategic planning.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A system for enumerating and accounting intangible assets, comprising:
a computer system for executing a program for enumerating and accounting the intangible assets and processing data describing the intangible assets interrelated with business parameters; and
a multi-dimensional chart having multiple domains which are assigned with types of intangible property and the business parameters;
wherein the multi-dimensional chart illustrates the intangible assets interrelated with the business parameters using multiple dimensions at the same time.

2. A system for enumerating and accounting intangible assets as defined in claim 1, wherein said multi-dimensional chart illustrates the intangible assets with specified fonts, color, background patterns and shades to differentiate properties, scope, interactions and status of the intangible assets.

3. A system for enumerating and accounting intangible assets as defined in claim 1, wherein said computer system rotates an axis or plane in the multi-dimensional chart to visualize a desired domain at a desired location of the multi-dimensional chart.

4. A system for enumerating and accounting intangible assets as defined in claim 1, said multi-dimensional chart illustrates said intangible assets based on relationships with at least one predetermined product.

5. A system for enumerating and accounting intangible assets as defined in claim 3, said multi-dimensional chart illustrates said intangible assets based on relationships with at least one group or division of a corporation or at least one corporation.

6. A method of enumerating and accounting intangible assets, comprising the following steps of:
determining requirements and scopes for representing intangible assets and business parameters;
determining a number of domains of a multi-dimensional chart based on the requirements and scopes;
assigning types of intangible assets and business parameters to the domains of the multi-dimensional chart;
creating lists of data describing particulars of each of the intangible assets;
completing the multi-dimensional chart by combining the lists of data, thereby illustrating the intangible assets with relationship with the business parameters in a multi-dimensional format.

7. A method of enumerating and accounting intangible assets as defined in claim 6, further comprising a step of specifying fonts, color, background patterns and shades to differentiate properties, scope, interactions and status of intangible assets.

8. A method of enumerating and accounting intangible assets as defined in claim 6, further comprising a step of rotating an axis or plane in the multi-dimensional chart to visualize a desired domain at a desired location of the multi-dimensional chart.

9. A method of enumerating and accounting intangible assets as defined in claim 6, said multi-dimensional chart illustrates said intangible assets based on relationships with at least one predetermined product.

10. A method of enumerating and accounting intangible assets as defined in claim 6, said multi-dimensional chart illustrates said intangible assets based on relationships with at least one group or division of a corporation or at least one corporation.

11. A method of enumerating and accounting intangible assets, comprising the following steps of:
determining requirements and scopes for graphically representing intangible assets;
determining a number of domains of a multi-dimensional chart based on the requirements and scopes where each domain is formed of a plane defined by two axes of the multi-dimensional chart;
assigning types of intangible assets and business parameters to the domains of the multi-dimensional chart and describing the domains by names of intangible assets and business parameters;
creating lists of data describing particulars of each of the intangible assets where said particulars include at least identification and status of each of the intangible assets;
completing the multi-dimensional chart by combining the lists of data, thereby illustrating the intangible assets with relationship with the business parameters in a multi-dimensional format.

12. A method of enumerating and accounting intangible assets as defined in claim 11 further comprising a step of organizing the lists of data of the intangible assets based on their properties, scope, interactions and status.

13. A method of enumerating and accounting intangible assets as defined in claim 11, further comprising a step of specifying fonts, color, background patterns and shades to differentiate properties, scope, interactions and status of intangible assets.

14. A method of enumerating and accounting intangible assets as defined in claim 11, further comprising a step of rotating an axis or plane in the multi-dimensional chart to visualize a desired domain at a desired location of the multi-dimensional chart.

15. A method of enumerating and accounting intangible assets as defined in claim 11, said multi-dimensional chart illustrates said intangible assets based on relationships with at least one predetermined product.

16. A method of enumerating and accounting intangible assets as defined in claim 11, said multi-dimensional chart illustrates said intangible assets based on relationships with at least one group or division of a corporation or at least one corporation.
